(19) United States
(12) Patent Application Publication
(10) Pub. No.: US 2023/0072529 A1
(43) Pub. Date: Mar. 9, 2023

(54) SYSTEM THAT PROVIDES INSURANCE SERVICES BASED ON ARTIFICIAL INTELLIGENCE

(71) Applicant: Buttle Information Systems Co., Ltd., Seoul (KR)

(72) Inventors: Young Han LEE, Gyeonggi-do (KR); Sung Jae SHIN, Seoul (KR)

(73) Assignee: Buttle Information Systems Co., Ltd., Seoul (KR)

(21) Appl. No.: 17/501,536

(22) Filed: Oct. 14, 2021

(30) Foreign Application Priority Data
Sep. 7, 2021 (KR) 10-2021-0119232

(51) Int. Cl. G06Q 40/08

(52) U.S. Cl. CPC G06Q 40/08; G06N 20/00

(57) ABSTRACT

Provided is a system for providing an insurance service based on artificial intelligence (AI), the system including a first terminal configured to provide an insurance consulting service and to filter potential customer information; a server configured to interact with the first terminal, to deliver the filtered potential customer information to the first terminal, and to deliver feedback on a quality of consultation for the insurance consulting service to the first terminal; and a plurality of second terminals configured to interact with the first terminal and the server, to deliver a request for the insurance consulting service to the server, and to receive customized insurance information about each of users from the server.

### CROSS-REFERENCE TO RELATED APPLICATIONS

This application claims the benefit under 35 USC § 119(a) of Korean Patent Application No. 10-2021-0119232 filed on Sep. 7, 2021 in the Korean Intellectual Property Office, the entire disclosure of which is incorporated herein by reference for all purposes.

### BACKGROUND

### 1. Field

At least one example embodiment relates to a method and system for providing an insurance service based on artificial intelligence (AI).

### 2. Description of Related Art

An existing insurance service employs a scheme of collectively setting and then publicizing insurance policies of interest by gender and age group to sell insurance products. Therefore, an insurance consulting service is provided through an additional factor, such as a subscription channel, regardless of characteristics of an insurance user or details covered by an insurance product.

Also, an existing insurance enrollment review, that is, underwriting is performed in consideration of demographic factors and accidental disease triggering factors. However, such factors have a reliability issue since there are many unverifiable parts and there is no choice but to rely heavily on notification details of an insurance user accordingly.

Also, unlike calculation of an individual risk, an enrollment review is performed based on a statistical basis of the entire population. Therefore, the actual individual risk may be inaccurately, that is, negatively judged.

From an insurance company's point of view, it is difficult to individually evaluate an insurance user and to differentiate between insurance companies, making it difficult to develop effective marketing strategies.

### SUMMARY

At least one example embodiment provides a method of providing an insurance service based on artificial intelligence (AI) and constructs a service providing method according thereto.

At least one example embodiment provides an insurance consulting service optimized for each customer.

At least one example embodiment provides an insurance consulting service to a customer that fails in an insurance review while providing an insurance consulting service optimized for each customer.

At least one example embodiment provides real-time/period-specific statistics related to a roboteller and an AI contact center in real time and daily.

According to an aspect of at least one example embodiment, there is provided a system for providing an insurance service based on artificial intelligence (AI), the system comprising a first terminal configured to provide an insurance consulting service and to filter potential customer information; a server configured to interact with the first terminal, to deliver the filtered potential customer information to the first terminal, and to deliver feedback on a quality of consultation for the insurance consulting service to the first terminal; and a plurality of second terminals configured to interact with the first terminal and the server, to deliver a request for the insurance consulting service to the server, and to receive customized insurance information about each of users from the server.

The server is configured to display insurance review processing results for insurance applications from the plurality of second terminals on a screen of the first terminal, to when an item for a completion status for a user of which review is not completed is selected from the insurance review processing results, display review results related to an insurance application of the user for each item, and to when an item for which the review results are not completed is selected, generate and output a standard script for a consulting service related to the selected item.

The server may be configured to control a recorded voice of the user for which review is not completed to be played in the first terminal from a part corresponding to the item for which the review results are not completed, and to send an additional information request for review completion to the second terminal based on the recorded voice.

The server may be configured to control a number of misguided items among insurance applications for which review is completed to be displayed on the first terminal, to when an item corresponding to the number of misguided items is selected, control information about a misguide-related check item and expression phrase and a corresponding time to be displayed on the first terminal, and to control advisory comments for an insurance reviewer related to the insurance consulting service to be displayed on the first terminal based on results of the misguide-related check item and expression phrase.

The server may be configured to display a completion status of insurance review, a review item, a completed item, and a completion rate on the first terminal as a screen in a form of a label in association with an AI automatic review processing status for the insurance application, and to display an insurance classification that is a subject of the insurance application, a product classification, a product name, and a standard compliance rate of a consulting service, and a prohibited word detection rate on the first terminal as the screen in the form of the label.

The server may be configured to control a first statistical screen related to a real-time status, a daily status, and a monthly status for AI automatic review results for the insurance application, a second statistical screen related to a status for each organization and for each type of review, a third statistical screen related to a detailed review status, a fourth statistical screen related to a misguided consultation, a fifth statistical screen related to consultation review criteria, and a sixth statistical screen related to a supplementary review failure call analysis to be generated and displayed on the first terminal.

The server may be configured to control a first statistical screen including first information about a progress rate, a completion rate, and a retry rate for the insurance application and second information about customer information verification, a delivery of terms, a handwritten signature, a reservation cancellation, and an early cancellation for each customer to be displayed on the first terminal.

The server may be configured to control statistical results for a retry rate and a retry success rate for each factor including a delivery of terms, a contract cancellation request, an early cancellation, a consent to collection of personal information, an insurance premium discount, and an insurance payment limitation to be displayed on the first terminal as a radial graph in relation to a consulting retry for a contract in which the insurance application is not completed.

The server may be configured to control a first statistical screen related to roboteller call statistics related to the insurance review processing results for the insurance application, a second statistical screen related to roboteller scenario statistics, a third statistical screen related to a real-time roboteller dashboard related to an insurance consultation, a fourth statistical screen related to statistics for each roboteller item, and a fifth statistical screen related to a speech-to-text (STT) conversion, and a sixth statistical screen related to a daily roboteller dashboard to be generated and displayed on the first terminal.

According to some example embodiments, it is possible to provide an AI-based automatic insurance review system that provides an insurance consulting service optimized for each customer.

Also, according to some example embodiments, it is possible to provide an insurance consulting service to a customer that fails in an insurance review while providing an insurance consulting service optimized for each customer.

Also, according to some example embodiments, it is possible to provide real-time/period-specific statistics related to a roboteller and an AI contact center in real time and daily by configuring results related to the roboteller and an AI contact center as a real-time/period-specific statistical screen and by providing various dashboards.

The aforementioned features and effects of the disclosure will be apparent from the following detailed description related to the accompanying drawings and accordingly those skilled in the art to which the disclosure pertains may easily implement the technical spirit of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an example of a configuration of a system for providing an insurance service based on artificial intelligence (AI) according to an example embodiment;

FIG. 2 illustrates an example of describing a system for providing an insurance service based on AI according to an example embodiment;

FIG. 3 illustrates an example of a screen for displaying an AI-based insurance review processing status in an insurance service providing system and describing an additional consultation providing method thereof according to an example embodiment;

FIG. 4 illustrates an example of providing a consultation (marketing) based on AI automatic review results in an insurance service providing system according to an example embodiment;

FIG. 5A illustrates an example of a screen for displaying an AI automatic review processing status according to an example embodiment and FIG. 5B illustrates an example of a screen for managing an AI automatic review reference rate according to an example embodiment;

FIG. 6 illustrates examples of various screens of an AI statistical analysis service in an insurance service providing system according to an example embodiment;

FIG. 7 illustrates an example of a screen related to complete sales monitoring in an insurance service providing system according to an example embodiment;

FIG. 8 illustrates an example of a screen related to complete sales monitoring statistics in an insurance service providing system according to an example embodiment;

FIG. 9 illustrates an example of a service range of an insurance service providing system and a work method according to an example embodiment;

FIG. 10A illustrates an example of an insurance service providing system of an inbound type according to an example embodiment, and FIG. 10B illustrates an example of an insurance service providing system of an outbound type according to an example embodiment;

FIG. 11 illustrates an example of a configuration in which an insurance service providing system provides a service in combination with a telemarketing (TM) providing system according to an example embodiment; and

FIG. 12 illustrates examples of various statistical configurations and dashboard configurations provided from an insurance service providing system according to an example embodiment.

### DETAILED DESCRIPTION

The aforementioned features and effects of the disclosure will be apparent from the following detailed description related to the accompanying drawings and accordingly those skilled in the art to which the disclosure pertains may easily implement the technical spirit of the disclosure.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure

In describing each drawing, like reference numerals refer to like elements throughout.

Although terms of “first,” “second,” and the like are used to explain various components, the components are not limited to such terms. These terms are used only to distinguish one component from another component.

For example, a first component may be referred to as a second component, or similarly, the second component may be referred to as the first component within the scope of the present disclosure. As used herein, the term “and/or” includes any and all combinations of one or more of the associated listed items.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art.

Terms defined in dictionaries generally used should be construed to have meanings matching contextual meanings in the related art and are not to be construed as an ideal or excessively formal meaning unless otherwise defined herein.

Also, components used herein, such as, for example, suffixes “˜unit/module/block,” etc., may be assigned or mixed in consideration of only ease of writing the specification and do not have distinct meaning or roles by themselves.

Hereinafter, the example embodiments are described with reference to the accompanying drawings such that those skilled in the art may easily carry out the disclosure. When it is determined that detailed description related to a known function or configuration unnecessarily obscures the gist of the disclosure in describing the example embodiments, the detailed description is omitted.

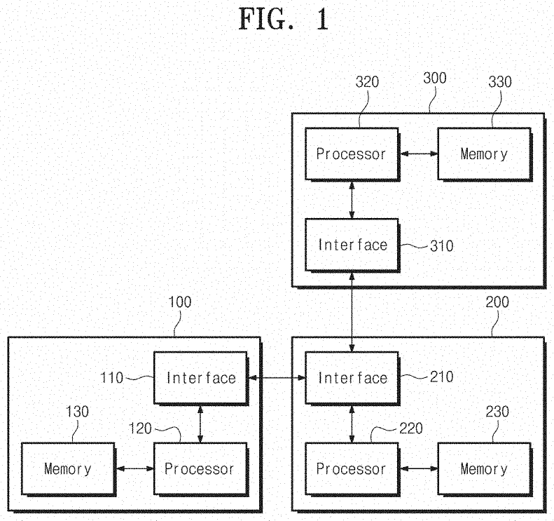

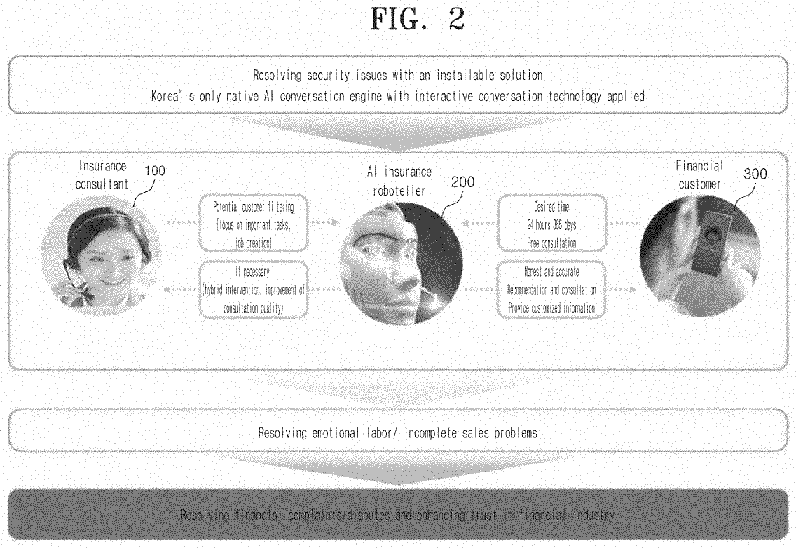

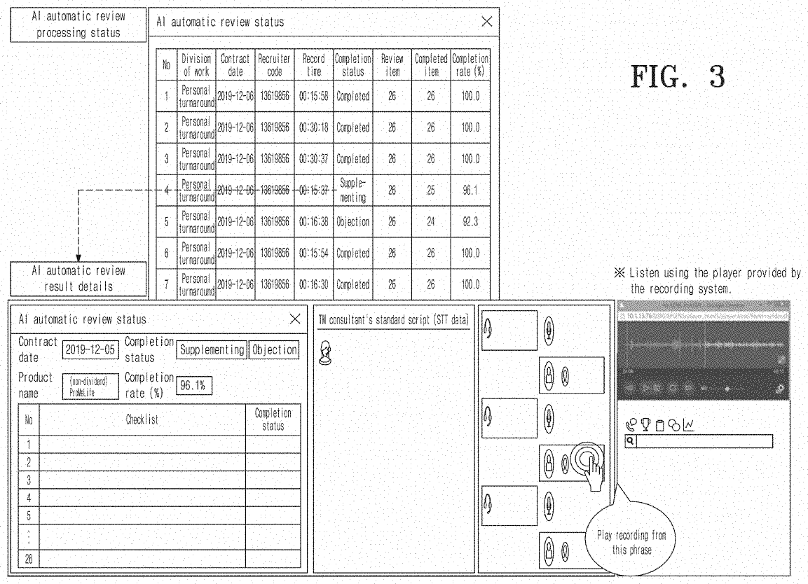

Hereinafter, a method and system for providing an insurance service based on artificial intelligence (AI) is described. FIG. 1 is a diagram illustrating an example of a configuration of a system for providing an insurance service based on AI according to an example embodiment, and FIG. 2 illustrates an example of describing a system for providing an insurance service based on AI according to an example embodiment.

Referring to FIGS. 1 and 2, an insurance service providing system may include a first terminal 100 that is a user terminal of an insurance consultant, a server 200 configured to provide an insurance service, and a second terminal 300 that is a user terminal of an insurance policy holder. The first terminal 100 may include an interface 110, a processor 120, and a memory 130. Similarly, the second terminal 300 may include an interface 310, a processor 320, and a memory 330. Also, the server 200 may include an interface 210, a processor 220, and a memory 230. The interfaces 110, 210, and 310 may be configured for interoperable connection between the first terminal 100 and the second terminal 300 through the server 200 using wired communication or wireless communication. The processors 120, 220, and 320 may be connected to the respective corresponding interfaces 110, 120, and 310 in an interoperable manner and may be configured to request, analyze, or provide an insurance service. The memories 130, 230, and 330 may be configured to store information related to the insurance service and customers.

Referring to FIGS. 1 and 2, the first terminal 100 is configured to provide an insurance consulting service and requests the server 200 to filter potential customer information. The server 200 is configured to interact with the first terminal 100 and to deliver the filtered potential customer information to the first terminal 100. The server 200 is configured to deliver feedback on a quality of consultation for the insurance consulting service to the first terminal 100.

The second terminal 300 is configured to interact with the first terminal 100 and the server 200, and to deliver a request for the insurance consulting service to the server 200. The second terminal 300 is configured to receive, from the server 200, insurance information customized for each of users, for example, a user using a corresponding terminal. Therefore, the second terminal 300 may be configured as a plurality of second terminals 300 including terminals of a plurality of users requesting the insurance consulting service.

Meanwhile, an AI-based insurance service providing system according to an example embodiment may display an AI-based insurance review processing status and review results on a screen in detail and may provide an additional consultation to a user of which review is not completed. In this regard, FIG. 3 illustrates an example of a screen for displaying an AI-based insurance review processing status in an insurance service providing system and describing an additional consultation providing method thereof according to an example embodiment. Referring to FIG. 3, a user may retrieve a review application status of a consultant on an AI automatic review processing status screen and, in response to a click on a specific review request, corresponding review results may be displayed in a pop-up form. The consistency and review results of 26 standard scripts (25 vehicles) may be displayed on a review result screen.

Referring to FIGS. 1 to 3, the server 200 may display insurance review processing results for insurance applications from the plurality of second terminals 300 on a screen of the first terminal 100. When an item for a completion status for a user of which review is not completed is selected from the insurance review processing results, the server 200 may display review results related to an insurance application of the user for each item. When an item for which the review results are not completed is selected, the server 200 may generate and output a standard script for a consulting service related to the selected item.

The server 200 may control a recorded voice of the user for which the review is not completed to be played in the first terminal 100 from a part corresponding to the item for which the review results are not completed. The server 200 may send an additional information request for review completion to the second terminal 300 based on the recorded voice.

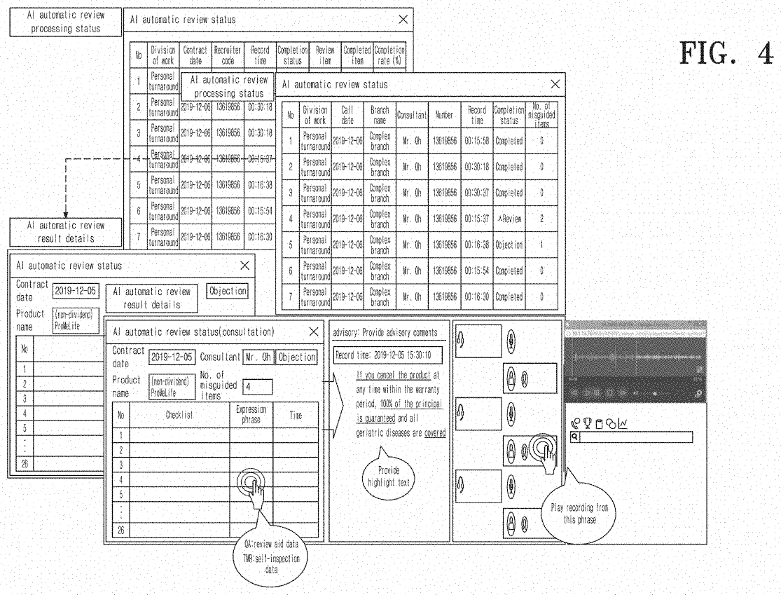

Meanwhile, the AI-based insurance service providing system according to an example embodiment may use AI automatic review results for consultation (marketing). In this regard, FIG. 4 illustrates an example of providing a consultation (marketing) based on AI automatic review results in an insurance service providing system according to an example embodiment. Referring to FIG. 4, AI automatic review results of unstructured consulting (marketing) recording may be provided as supplementary data for insurance review and a consultant may use the same for self-examination.

Referring to FIGS. 1 to 4, the server 200 controls a number of misguided items among insurance applications for which the review is completed to be displayed on the first terminal 100. When an item corresponding to the number of misguided items is selected, the server 200 controls information about a misguide-related check item and expression phrase and a corresponding time to be displayed on the first terminal 100.

The server 200 controls advisory comments for an insurance reviewer related to the insurance consulting service to be displayed on the first terminal 100 based on results of the misguide-related check item and expression phrase.

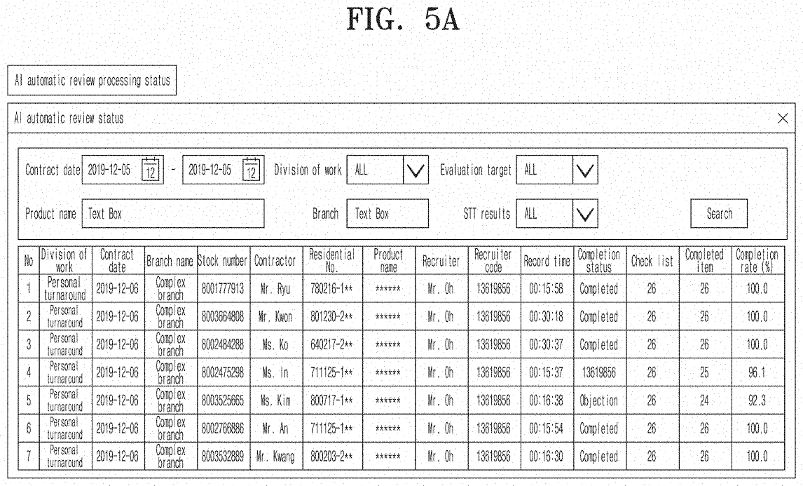

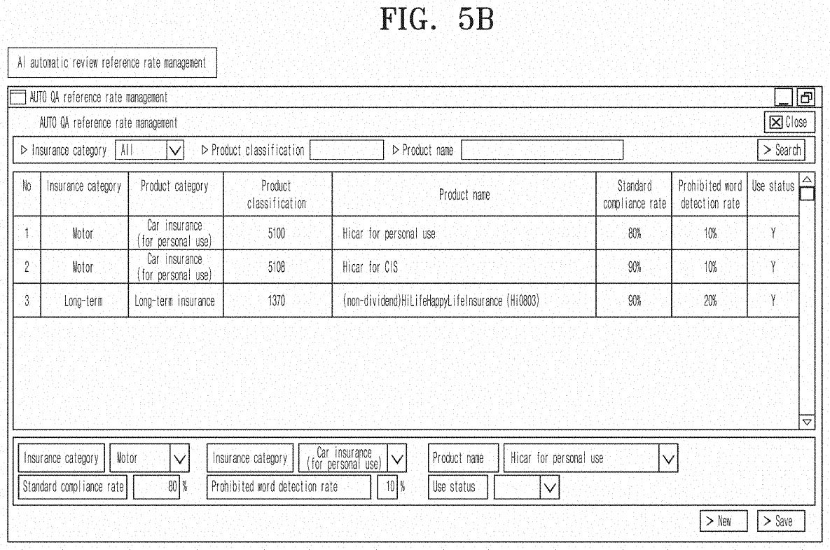

Meanwhile, the insurance service providing system according to an example embodiment may display an AI automatic review processing status and may manage an AI automatic review reference rate. In this regard, FIG. 5A illustrates an example of a screen for displaying an AI automatic review processing status according to an example embodiment and FIG. 5B illustrates an example of a screen for managing an AI automatic review reference rate according to an example embodiment.

Referring to FIG. 5A, the insurance service providing system displays a page that allows a user to retrieve and analyze a speech-to-text (STT) status by hour and by day on an AI automatic review processing status screen. Also, the user selects a corresponding STT list, retrieves information of a recorded file being analyzed, and listens to audio recording data. Likewise, referring to FIG. 5B, the insurance service providing system displays a page that allows a user to retrieve and analyze an STT status by hour and by day on an AI automatic review processing status screen. Also, the user selects a corresponding STT list, retrieves information of a recorded file being analyzed, and listens to audio recording data.

Referring to FIGS. 1 to 5B, the server 200 displays a completion status of insurance review, a review item, a completed item, and a completion rate on the first terminal 100 as a screen in a form of a label in association with an AI automatic review processing status for an insurance application. The server 200 displays an insurance classification that is a subject of an insurance application, a product classification, a product name, and a standard compliance rate of a consulting service, and a prohibited word detection rate on the first terminal 100.

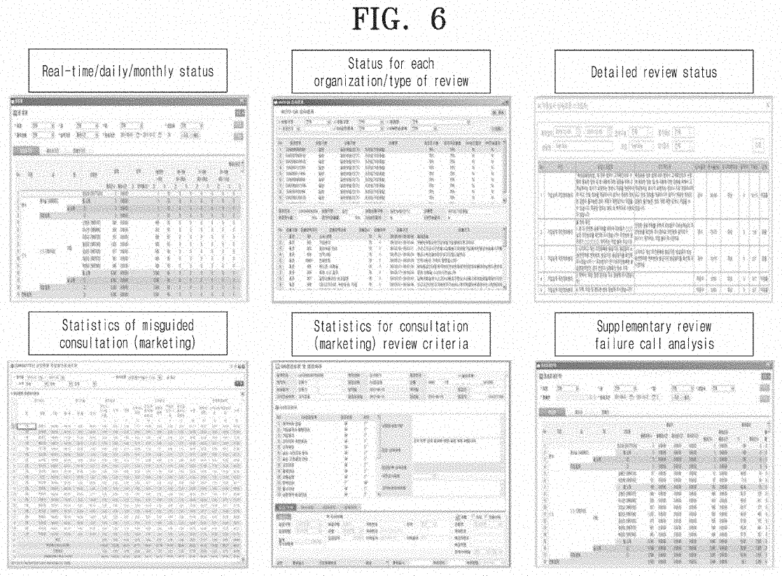

The insurance service providing system according to an example embodiment may provide an AI statistical analysis service. In this regard, FIG. 6 illustrates examples of various screens of an AI statistical analysis service in an insurance service providing system according to an example embodiment. Referring to FIG. 6, statistical screens for a real-time/daily/monthly status and for a status for each organization/type of review are configured. Data related to AI review results may be used as a predictive analysis for future review and a customer response index.

Referring to FIGS. 1 to 6, the server 200 may display a plurality of statistical screens, for example, a first statistical screen to a sixth statistical screen as illustrated in FIG. 6. The server 200 may generate a first statistical screen related to a real-time status, a daily status, and a monthly status for AI automatic review results for the insurance application, a second statistical screen related to a status for each organization and for each type of review, a third statistical screen related to a detailed review status, a fourth statistical screen related to a misguided consultation, a fifth statistical screen related to consultation review criteria, and a sixth statistical screen related to a supplementary review failure call analysis. The server 200 may control the first statistical screen to the sixth statistical screen to be generated and controlled on the first terminal 100.

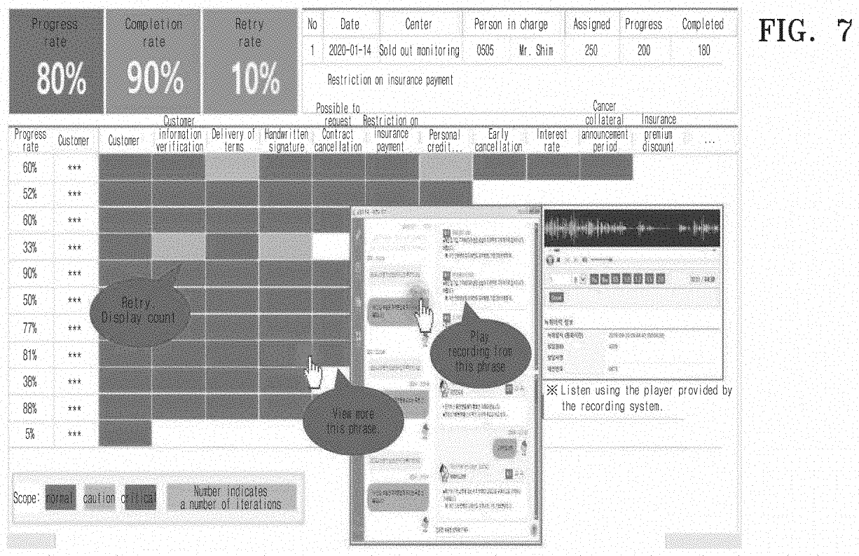

The insurance service providing system according to an example embodiment may provide a screen related to complete sales monitoring. FIG. 7 illustrates an example of a screen related to complete sales monitoring in an insurance service providing system according to an example embodiment. Referring to FIG. 7, a screen in a form of real-time and cumulative statistics and a real-time conversation retrieval screen capable of monitoring a complete sales monitoring roboteller call statistics and cases in progress are provided.

Referring to FIGS. 1 to 7, the server 200 controls a first statistical screen including first information about a progress rate, a completion rate, and a retry rate for the insurance application and second information about customer information verification, a delivery of terms, a handwritten signature, a reservation cancellation, and an early cancellation for each customer to be displayed on the first terminal 100.

The insurance service providing system according to an example embodiment may provide a roboteller's daily status screen. In this regard, the insurance service providing system may provide a screen in a form of real-time and cumulative statistics and a real-time conversation retrieval screen capable of monitoring a complete sales monitoring roboteller call statistics and cases in progress. Also, the insurance service providing system may provide a complete sales monitoring statistical screen. In this regard, the insurance service providing system may provide a screen in a form of real-time and cumulative statistics and a real-time conversation retrieval screen capable of monitoring a complete sales monitoring roboteller call statistics and cases in progress.

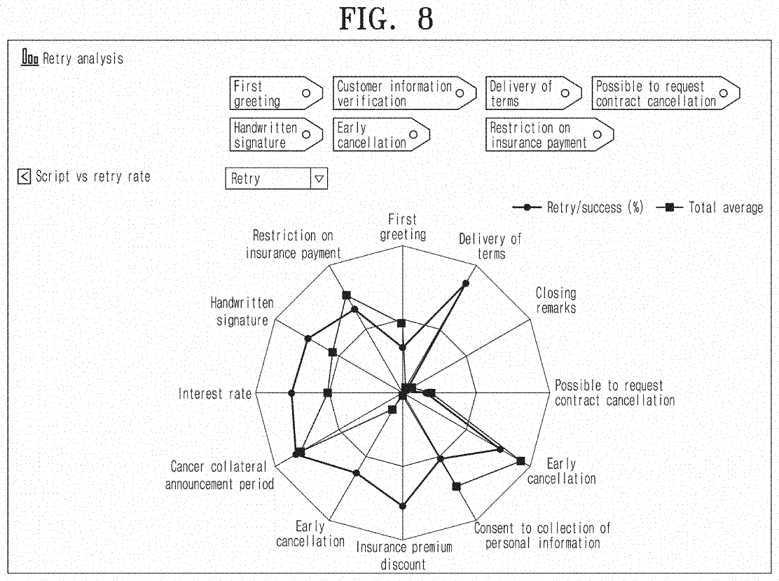

Meanwhile, the insurance service providing system according to an example embodiment may provide a statistical service related to a retry analysis in association with complete sales monitoring statistics. In this regard, FIG. 8 illustrates an example of a screen related to complete sales monitoring statistics in an insurance service providing system according to an example embodiment.

Referring to FIGS. 1 to 8, the server 200 controls statistical results for a retry rate and a retry success rate for each factor including a delivery of terms, a contract cancellation request, an early cancellation, a consent to collection of personal information, an insurance premium discount, and an insurance payment limitation to be displayed on the first terminal 100 as a radial graph in relation to a consulting retry for a contract in which the insurance application is not completed.

The insurance service providing system according to an example embodiment may provide various types of common statistical results. In this regard, in FIG. 8, the insurance service providing system provides common statistical results in various forms.

Referring to FIGS. 1 to 8, the insurance service providing system provides real-time/time-specific statistics related to a roboteller and an AI contact center in real time and daily and provides a real-time operating environment through a dashboard by constructing results for a roboteller and an AI contact center as a real-time/period-specific statistical screen and by providing various dashboards. In this regard, the server 200 controls a plurality of statistical screens, for example, the first statistical screen to the sixth statistical screen to be generated and displayed on the first terminal 100.

The server 200 controls a first statistical screen related to roboteller call statistics related to the insurance review processing results for the insurance application, a second statistical screen related to roboteller scenario statistics, a third statistical screen related to a real-time roboteller dashboard related to an insurance consultation, a fourth statistical screen related to statistics for each roboteller item, and a fifth statistical screen related to an STT conversion, and a sixth statistical screen related to a daily roboteller dashboard to be generated and displayed on the first terminal 100.

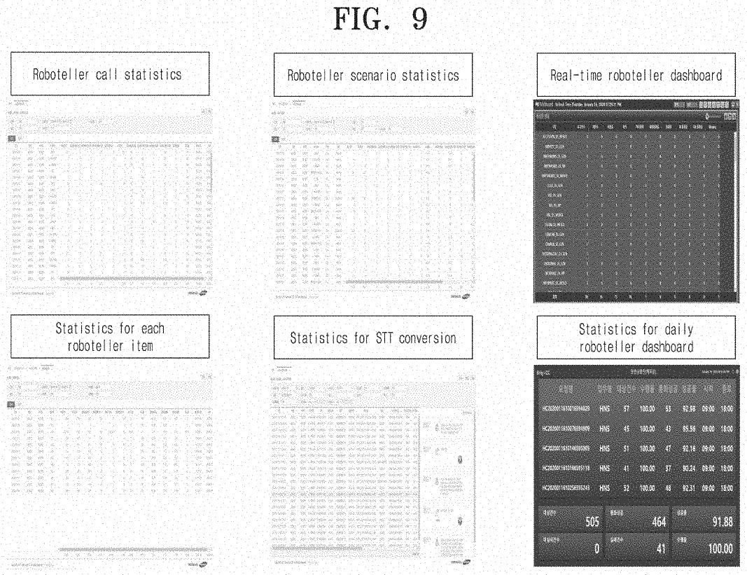

Meanwhile, a service range and a work method of the insurance service providing system according to an example embodiment may be provided in various forms. In this regard, FIG. 9 illustrates an example of a service range of an insurance service providing system and a work method according to an example embodiment. Referring to FIGS. 1, 2, and 9, the service range of the insurance service providing system may include a description of terms (summary and visualization), a conclusion of an insurance contract, and a happy call service in addition to an insurance consultation (a product description, a document guide, and a product recommendation). Therefore, the server 200 delivers insurance consultation related information about an insurance product description, a document guide, and a product recommendation for each customer to the first terminal 100 and the second terminal 200 based on the filtered potential customer information and controls the delivered information to be displayed on the first terminal 100 and the second terminal 200. Also, the server 200 may control the first terminal 100 and the second terminal 200 such that a description of terms (summary and visualization), a conclusion of an insurance contract, and a happy call service may be provided for each customer.

The work method of the insurance service providing system may control a service planning to be implemented in cooperation with a non-life insurer. Also, the server 200 may learn product selection and incomplete sales case data based on a machine learning and then, may select an insurance product for each customer based on the learned data, may determine whether of incomplete sales, and may modify an incompletely sold insurance contract. Also, the work method may apply a prohibition of unfair acts according to the Insurance Business Act, may select a learning scenario, and may perform a roboteller learning using a machine learning/deep learning method. Therefore, the server 200 may provide an insurance consulting service optimized for each customer based on customer information that is filtered using the machine learning or deep learning method.

The insurance consulting service optimized for each customer may be provided in an STT form. In this regard, STT conversion results of all calls may be stored according to an information storage standard and statistics/inquiry/search/playback functions may be implemented using a user-friendly user interface (UI). Here, a keyword search is available from the STT conversion results and, in the case of clicking on a word, setting a speed of listening to recorded audio from the clicked word/view a wavelength/font size, etc., may be set. Also, the STT conversion results are stored in a memory or a database of the server 200. Here, it is possible perform search, playback, inquiry of statistics, and providing a list of all recordings in various dashboards and lists.

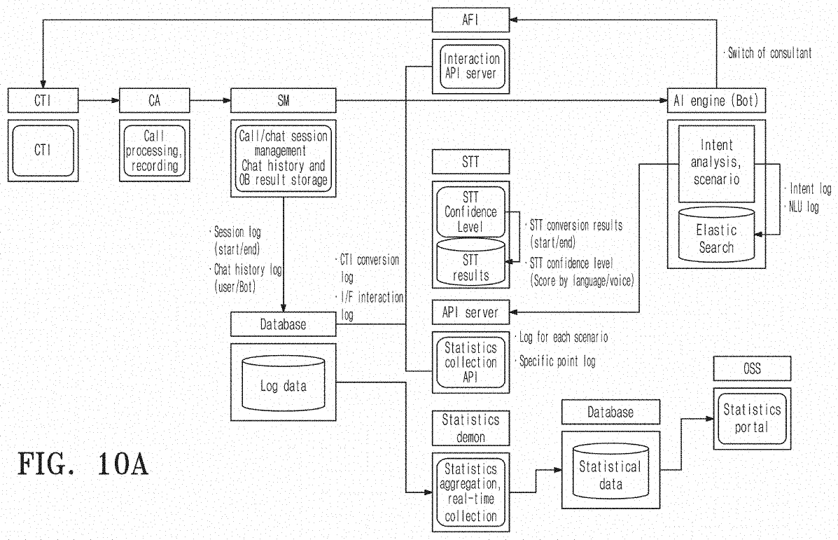

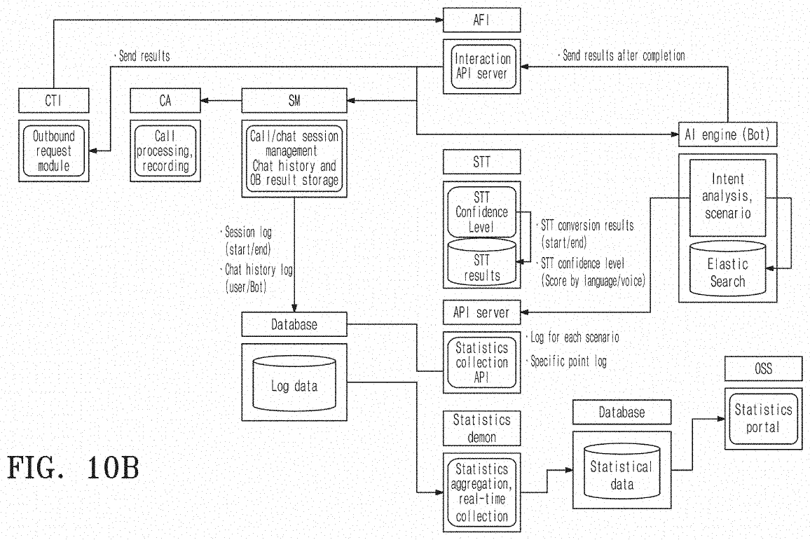

The work method of the insurance service providing system according to an example embodiment may be provided in a form of an inbound service and an outbound service. In this regard, FIG. 10A illustrates an example of an insurance service providing system of an inbound type according to an example embodiment, and FIG. 10B illustrates an example of an insurance service providing system of an outbound type according to an example embodiment.

Referring to FIGS. 1, 2, and 10A, the server 200 performs a call/chat session management and a chat history and result storage. Also, the server 200 may perform an STT conversion, collection of statistics, AI-based intent analysis, and an insurance consultation/contract scenario through an API server.

Referring to FIGS. 1, 2, and 10B, the server 200 performs a call/chat session management and a chat history and result storage. Also, the server 200 may perform an STT conversion, collection of statistics, AI-based intent analysis, and an insurance consultation/contract scenario through an API server. Meanwhile, in the outbound service, there is a difference in that an AI engine also sends results of performing an intent analysis and a scenario to a service module (SM) that performs a call/chat session management.

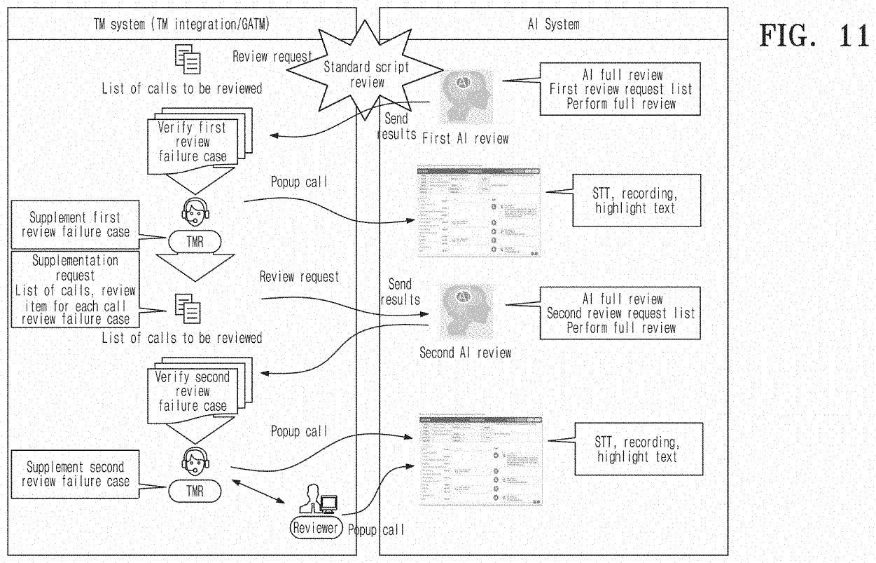

The insurance service providing system according to an example embodiment may provide a service in combination with a telemarketing (TM) providing system. In this regard, FIG. 11 illustrates an example of a configuration in which an insurance service providing system provides a service in combination with a telemarketing (TM) providing system according to an example embodiment.

Referring to FIGS. 1, 2, and 11, the insurance service providing system may verify a first review failure case from a list of calls to be reviewed and to make a supplementation request by referring to a review item for each call. Also, the insurance service providing system may verify a second review failure case from the list of calls to be reviewed and to make a supplementation request.

In response to a review request for the list of calls to be reviewed and a result sending thereof, an AI module of the server 200 may perform an AI full review. To this end, the server 200 may perform an AI full review based on STT, recording, and highlight text. Also, in response to a supplementation request for the second review failure case, the server 200 may perform an AI full review based on STT, recording, and highlight text. In this regard, the server 200 supplements insurance consultation/contract for the second review failure case using customer information and AI full review results acquired when supplementing the first review failure case.

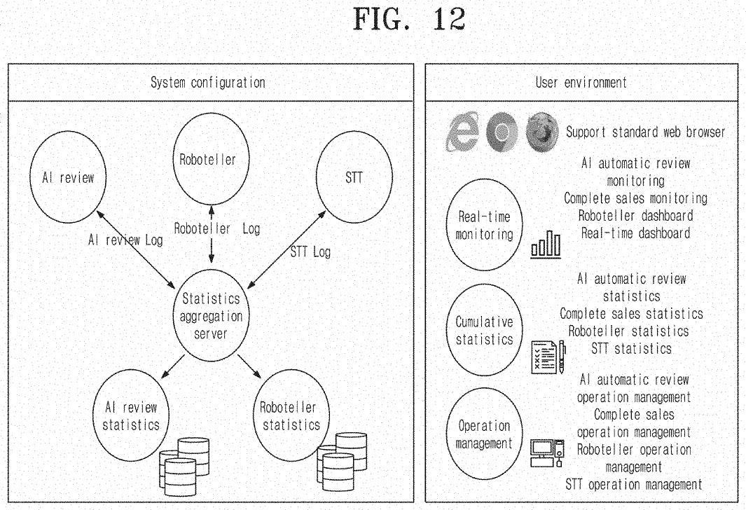

As described above, the insurance service providing system according to an example embodiment may provide various statistics and dashboards. In this regard, FIG. 12 illustrates various statistical configurations and dashboard configurations provided from an insurance service providing system according to an example embodiment. Referring to FIGS. 1, 2, and 12, a statistical system refers to a system for convenience securement in operating a smart contact center, systematic management, and real-time/period-specific cumulative statistics, and integrates and manages AI automatic review, a roboteller, an STT, and the like.

For such a system configuration, the server 200 may include an AI review module, a roboteller module, an STT conversion module, an AI review statistics module, and a roboteller statistics module. Also, the server 200 may further include a statistics aggregation module that interacts with the AI review module, the roboteller module, the STT conversion module, the AI review statistics module, and the roboteller statistics module.

The method and system for providing an insurance service based on AI according to example embodiments is described above. The method and system for providing an insurance service based on AI according to example embodiments may achieve the following technical effects.

According to some example embodiments, it is possible to provide an AI-based automatic insurance review system that provides an insurance consulting service optimized for each customer.

Also, according to some example embodiments, it is possible to provide an insurance consulting service to a customer that fails in an insurance review while providing an insurance consulting service optimized for each customer.

Also, according to some example embodiments, it is possible to provide real-time/period-specific statistics related to a roboteller and an AI contact center in real time and daily by configuring results related to the roboteller and an AI contact center as a real-time/period-specific statistical screen and by providing various dashboards.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

According to software implementation, not only procedures and functions described herein but also design and parameter optimization for the respective components may be implemented as a separate software module. A software code may be implemented as a software application written in a suitable program language. The software code may be stored in a memory and may be executed by a controller or a processor.

What is claimed is:

1. A system for providing an insurance service based on artificial intelligence (AI), the system comprising:
a first terminal configured to provide an insurance consulting service and to filter potential customer information;
a server configured to interact with the first terminal, to deliver the filtered potential customer information to the first terminal, and to deliver feedback on a quality of consultation for the insurance consulting service to the first terminal; and
a plurality of second terminals configured to interact with the first terminal and the server, to deliver a request for the insurance consulting service to the server, and to receive customized insurance information about each of users from the server,
wherein the server is configured to
display insurance review processing results for insurance applications from the plurality of second terminals on a screen of the first terminal,
when an item for a completion status for a user of which review is not completed is selected from the insurance review processing results, display review results related to an insurance application of the user for each item, and
when an item for which the review results are not completed is selected, generate and output a standard script for a consulting service related to the selected item.

2. The system of claim 1, wherein the server is configured to
control a recorded voice of the user for which review is not completed to be played in the first terminal from a part corresponding to the item for which the review results are not completed, and
send an additional information request for review completion to the second terminal based on the recorded voice.

3. The system of claim 1, wherein the server is configured to control a number of misguided items among insurance applications for which review is completed to be displayed on the first terminal,
when an item corresponding to the number of misguided items is selected, control information about a misguide-related check item and expression phrase and a corresponding time to be displayed on the first terminal, and
control advisory comments for an insurance reviewer related to the insurance consulting service to be displayed on the first terminal based on results of the misguide-related check item and expression phrase.

4. The system of claim 1, wherein the server is configured to
display a completion status of insurance review, a review item, a completed item, and a completion rate on the first terminal as a screen in a form of a label in association with an AI automatic review processing status for the insurance application, and
display an insurance classification that is a subject of the insurance application, a product classification, a product name, and a standard compliance rate of a consulting service, and a prohibited word detection rate on the first terminal as the screen in the form of the label.

5. The system of claim 1, wherein the server is configured to control a first statistical screen related to a real-time status, a daily status, and a monthly status for AI automatic review results for the insurance application, a second statistical screen related to a status for each organization and for each type of review, a third statistical screen related to a detailed review status, a fourth statistical screen related to a misguided consultation, a fifth statistical screen related to consultation review criteria, and a sixth statistical screen related to a supplementary review failure call analysis to be generated and displayed on the first terminal.

6. The system of claim 1, wherein the server is configured to control a first statistical screen including first information about a progress rate, a completion rate, and a retry rate for the insurance application and second information about customer information verification, a delivery of terms, a handwritten signature, a reservation cancellation, and an early cancellation for each customer to be displayed on the first terminal.

7. The system of claim 1, wherein the server is configured to control statistical results for a retry rate and a retry success rate for each factor including a delivery of terms, a contract cancellation request, an early cancellation, a consent to collection of personal information, an insurance premium discount, and an insurance payment limitation to be displayed on the first terminal as a radial graph in relation to a consulting retry for a contract in which the insurance application is not completed.

8. The system of claim 1, wherein the server is configured to control a first statistical screen related to roboteller call statistics related to the insurance review processing results for the insurance application, a second statistical screen related to roboteller scenario statistics, a third statistical screen related to a real-time roboteller dashboard related to an insurance consultation, a fourth statistical screen related to statistics for each roboteller item, and a fifth statistical screen related to a speech-to-text (STT) conversion, and a sixth statistical screen related to a daily roboteller dashboard to be generated and displayed on the first terminal.
